(19) United States
(12) Patent Application Publication
(10) Pub. No.: US 2019/0283035 A1
(43) Pub. Date: Sep. 19, 2019

(54) ROLL CRUSHER CRUSHING TEETH ATTACHMENT

(71) Applicant: SANDVIK INTELLECTUAL PROPERTY AB, Sandviken (SE)

(72) Inventors: Udo FISCHER, Lindlar (DE); Jochen HEIB, Saarbrucken (DE); Guido BOTTCHER, Koln (DE)

(21) Appl. No.: 16/463,069

(22) PCT Filed: Nov. 23, 2016
(86) PCT No.: PCT/EP2016/078483

§ 371 Date: May 22, 2019

(51) Int. Cl. B02C 13/28

(52) U.S. Cl. CPC B02C 13/2804; B02C 2210/02

(57) ABSTRACT

A crushing segment forming part of a crushing roll of a roll crusher, the segment including a main body to mount at least one crushing tooth. A filler material is interposed between respective first and second mount faces provided at the tooth and main body so as to provide enhanced surface area contact between the tooth and segment and increase the capability of the tooth and segment assembly to withstand significantly high loading forces during use.

### FIELD OF INVENTION

The present invention relates to a crushing segment forming part of a crushing roll of a roll crusher and in particular, although not exclusively, to a crushing segment carrying at least one tooth coupled to the segment via an intermediate filler material.

### BACKGROUND ART

A variety of different techniques and mechanical attachments are used to fix crushing teeth (alternatively termed crushing picks) to suitable mount structures or main bodies including segments, rings and the like that may be rotated or driven by a motor to force the teeth against bulk material. Mechanical attachment of the teeth is typically achieved via four approaches: i) form closure using bore holes and axial locking devices; ii) screwed attachment with form closure by machined surfaces; iii) welding or iv) combined screwed attachment and welding.

Form closure by mean of bore holes and axial locking devices typically involves a split pin, bolt, screw or threaded pin inserted between and coupling the tooth to the roll or segment main body. This attachment method is typically suitable for low to medium crushing forces and is used in milling processes for example feeder breakers, road headers and semi-crushing machines. Attachment of a crushing tooth via mechanical attachment bolts is described in WO 83/02071, WO 98/58739 and US 2014/0117133.

Screwed attachment with form closure provides relatively quick interchange of worn teeth. When implemented for small to medium crushing force applications, mechanical machining of opposed contact surfaces is typically not required. However, for high demand applications, precise mechanical machining is needed to ensure maximum surface area contact between tooth and mount body (i.e., roll segment) and hence maximised and efficient force transmission. However, due to deformation of the machined parts following exposure to high crushing forces and general wear, it is common for the profile of the mount body to deform and no longer correspond to the machined profile of the replacement tooth.

Tooth attachment and interchange by perimeter seam welding is hazards to personnel and time and labour intensive. This is due to the weld process typically involving grinding and flame-cutting at the weld region. Welding of the component parts unavoidably fatigues the material properties and introduces additional stress due to weld distortion. Additionally, weld notches appreciably reduce the joint strength and mechanical durability.

A combined screwed and welded attachment mechanism is typically a two-stage process. In particular, if the screwed connection proves to be insufficient to achieve a stable attachment, welding is typically applied at the perimeter region between the tooth and the main body to try and impart additional mechanical attachment. However, introducing welding is disadvantages as described. Accordingly, what is required is a mechanism for attachment of a crushing tooth (pick) at a main body suitable for high crushing force applications that addresses the above problems.

### SUMMARY OF THE INVENTION

It is an objective of the present invention to provide a mechanism for the attachment of crushing teeth (alternatively termed crushing picks) to a main body such as a crushing segment, ring, shaft, drum and the like that provides convenient assembly and dismount of the teeth in addition to the effective transmission of high loading forces encountered during use. It is a further objective to provide an attachment mechanism that specifically avoids the problem associated with welded seams and machining, milling or grinding of mounting surfaces between regions of the crushing teeth and main body.

It is a specific objective of the present invention to provide a crushing tooth mountable at a main body having a maximised surface area contact between the two components to as to provide efficient and effective loading force transfer. The objectives are achieved via utilisation of a filler material capable of being interposed between respective first and second mount faces (provided at the main body and the crushing tooth respectively). In particular, the filler material comprises a pre-set shape deformation characteristic, during installation of the tooth at the main body, so as to conform to and adopt the shape profile of the joint region that is defined by the first and second mount faces of the main body and crushing tooth, respectively. Such a configuration is advantageous to completely fill or occupy the region between the crushing tooth and the main body (mount region) so as to achieve a high level of form closure which in turn enables transmitted and absorption of significantly high crushing forces in three dimensions including in particular radial and axial aligned forces at the tooth and main body.

The subject invention is advantageous to avoid a need to weld or machine the mount surfaces and hence the hazards and associated time and labour intensive processes. Accordingly, the subject invention is advantageous to allow utilisation of crushing teeth formed from significantly harder materials that would otherwise be difficult to mechanically machine. The close form fitting that is possible via the subject invention provides a mechanism of tooth attachment that provides significantly higher resistance to teeth breakage and detachment during use and accordingly enables the assembled components to be utilised for high demand applications such as for roll crushers and in particular sizers and double roll crushers capable of operation with high feed size (up to 2500 mm); high throughput capacity (up to 12000 mtph) and with a reduction ratio of up to 1:6 for example.

According to a first aspect of the present invention there is provided a crushing segment forming a part of a crushing roll of a roll crusher, the segment comprising: a main body provided or mountable at a crushing roll, the main body having at least one tooth mount region defined by a first mount face of the main body; a crushing tooth having a second mount face mountable at the tooth mount region via positionally opposed mating contact between the first and second mount faces; a mechanical attachment to releasably attach the crushing tooth to the mount region; characterised by: a filler material interposed between and extending over a majority of each of the positionally opposed first and second mount faces, the majority of the first and second mount faces in frictional mating contact via the interposed filler material.

Reference within this specification to the filler material extending over ‘a majority’ of the first and second mount faces, encompasses positioning of the filler material to occupy most, nearly all or the complete surface areas of the opposed mating first and second mount faces. The total respective surface areas of the first and second mount faces may be defined as the area of the respective faces that are positioned opposed to one another in close or near touching contact. Accordingly, an outer perimeter of the first and second mount surfaces may be defined by the respective regions of the tooth and main body that are not positionable in positionally opposed, close fitting or near touching contact when the tooth is held in position at the mount region.

Preferably, the filler material is a settable material configured to transition from a flowable fluid form to a generally solid form. Optionally, the filler material is a polymer resin. More preferably, the polymer resin may be an epoxy based material. Optionally, the filler material is capable of adopting a pre-cured or pre-set fluid form having a medium or low viscosity so as to be capable of being applied as a paste-like material onto the first and/or second mount face. The filler material may be configured to cure or set via a variety of different curing mechanisms such as crosslinking, condensation or radial based chemical reactions so as to provide a generally solid polymer resin. Using a setting resin allows firstly the filler material to flow within and occupy completely the volume of the cavity defined by the opposed tooth and mount region and secondly to be self-moulding and adopt the shape profile of the opposed mount faces and hence what may be regarded as a mould volume defined by the opposed mount faces. The filler material is advantageous to provide complete frictional mating of the tooth and crushing segment, with zero or minimised gaps, voids or cavities in between these two components.

Optionally, the filler material may comprise a particulate additive. The particulate additive may comprise a metal powder. Alternative particulates may comprise carbon based particulates, carbides or carbide based compounds. The particulate additive is configured to enhance the compressive strength of the filler material. Optionally, the particulate additive may impart a mechanical elasticity to the filler material so as to be capable of elastic mechanical deformation in response to the high impact loading forces transmitted between the tooth and the crushing segment. Optionally, the particulate additive may be included within the filler material in the range 40 to 95 wt % based on a total weight of filler material. More preferably, the particulate additive may be included at 80 to 95 wt % or 90 to 95 wt %.

Optionally, the mechanical attachment may comprise any one or a combination of the set of: a bolt, a screw, a pin, a bayonet fixing, a tongue and groove attachment. Due to the complete or near complete form filling of the cavity between the tooth and crushing segment, that in turn provides 90 to 100% surface area contact between the tooth and crushing segment, the relative size of the mechanical attachment may be minimised. This is further advantageous in that any bore holes within the tooth and/or the crushing segment may be minimised to optimise the mechanical strength of these components and reduce the likelihood and the magnitude of stress concentration. That is, as a result of the high surface area contact between the tooth and mount region, the compressive force required to attach the tooth the crushing segment is minimised. It will be appreciated that for conventional bore hole and bolt attachments, a significant force is needed to try and bring misaligned or imperfect surfaces (of the tooth and crushing segment) into alignment to achieve the desired frictional mating contact.

Preferably, the filler material extends over 85 to 100% of the positionally opposed first and second mount faces. More preferably, the filler material extends over the entire surface areas of the first and second mount faces to occupy completely the region between the opposed first and second mount faces and provide complete indirect coupling of said faces. As indicated, such a configuration is advantageous to avoid the need for machining of such surfaces in order to try and achieve maximised surface area contact. Accordingly and preferably, the filler material extends to generally completely cover the positionally opposed first and second mount faces so as to occupy generally all of a junction between the mount region and the crushing tooth.

Optionally, the mount region may comprise a jib projecting outwardly from the main body and the crushing tooth comprises a cavity having a shape profile complementary to that of the jib to enable the jib to be seated within the cavity, the jib and the cavity defining at least a part of the respective first and second mount face. The jib is advantageous to further facilitate the transmission of crushing forces through the junction of the tooth and the crushing segment (the crushing segment mount region). The jib may be further advantageous to absorb mechanical forces to provide isolation of the mechanical attachment (i.e. bolt) from the crushing forces during use. This configuration facilitates the minimised dimensions of the mechanical attachment for example the diameter and axial length of the bolt and receiving bores for the advantages indicated. The jib may comprise any cross sectional shape profile to assist with absorption and transmission of the mechanical forces.

Optionally, the jib may project from the tooth and the main body of the crushing tool may comprise a cavity to receive the jib. The configuration of the jib and cavity with regard to absorption and transmission of mechanical forces according to such further embodiments is the same as described herein. Optionally, both the tooth and main body may comprise a corresponding jib and cavity configured to interlock respectively as the tooth is mounted at the main body. Optionally, the tooth and main body may comprise a plurality of jibs and cavities so as to provide an interlocking configuration with each jib of the tooth configured to be received within corresponding respective cavities of the main body. Such a configuration may also be applied to the primary embodiment described herein in which at least one jib projects from the main body and at least one cavity is formed at the tooth.

Preferably, the segment further comprises at least one channel, groove, rib, shoulder or stepped region provided at the mount region and/or the crushing tooth to define at least a part of the respective first and/or second mount face. Such features are advantageous to facilitate with the delivery and distribution of the filler material within the complete volume between the tooth and the mount region in addition to providing a profiled region of mechanical attachment between the tooth and crushing segment that facilitates absorption and transmission of the crushing forces in use.

Preferably, the mechanical attachment comprises a bolt extending at least partially through the main body (at the mount region) and the crushing tooth. More preferably, the tooth and/or the main body comprise at least one threaded bore configured to cooperate with complementary threads provided at the bolt for mechanical attachment of the tooth to the crushing segment.

Preferably, the segment comprises a plurality of crushing teeth, the filler material interposed respectively between each of the mount regions and the teeth. Accordingly, the teeth may be independently mounted at the crushing segment via respective mechanical attachments with complete form closure (frictional contact between the respective mount faces of the tooth and) achieved by respective volumes of filler material present between each tooth and mount region.

According to a second aspect of the present invention there is provided a crushing roll for a roll crusher comprising at least one crushing segment as claimed herein.

According to a third aspect of the present invention there is provided a roll crusher comprising at least one crushing roll as claimed herein.

### BRIEF DESCRIPTION OF DRAWINGS

A specific implementation of the present invention will now be described, by way of example only, and with reference to the accompanying drawings in which:

FIG. 1 is a perspective view of a double roll crusher having a pair of opposed rotating rolls that carry crushing teeth mounted on respective crushing segments according to a specific implementation of the present invention;

FIG. 2 is a perspective view of one of the crushing segments of FIG. 1 according to a specific implementation of the present invention;

FIG. 3 is a magnified view of a tooth mounting region of the crushing segment of FIG. 2 with the crushing tooth removed for illustrative purposes;

FIG. 4 is a forward perspective view of one of the crushing teeth of FIG. 2;

FIG. 5 is a rear perspective view of the crushing tooth of FIG. 4;

FIG. 6 is a magnified rear perspective view of the tooth of FIG. 5;

FIG. 7 is a cross section through A-A of FIG. 2.

### DETAILED DESCRIPTION OF PREFERRED EMBODIMENT OF THE INVENTION

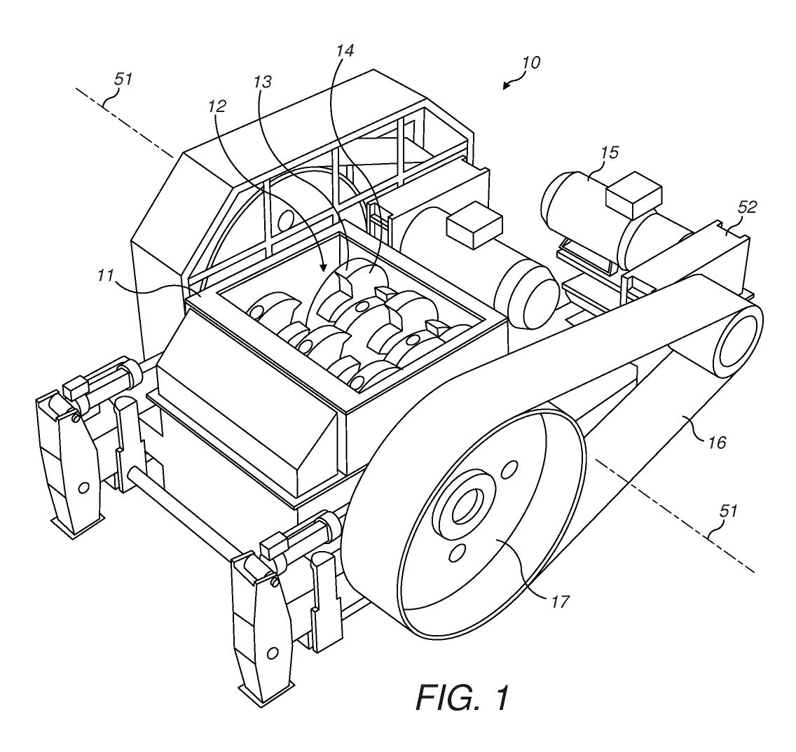

Referring to FIG. 1, a roll crusher 10 comprises a crushing chamber 11 that mounts a pair of positionally opposed crushing rolls illustrated generally by reference 12. Each roll 12 comprises a drive axle (not shown) that is mechanically driven via gears 52 coupled to a pair of fly wheels 17 that are in turn driven by electric motors 15 via respective drive belts 16. Rolls 12 are typically counter-rotating to a provide primary, secondary or tertiary crushing of soft to hard materials such as stone, clay, different types of ore, coal and other similar bulk raw materials.

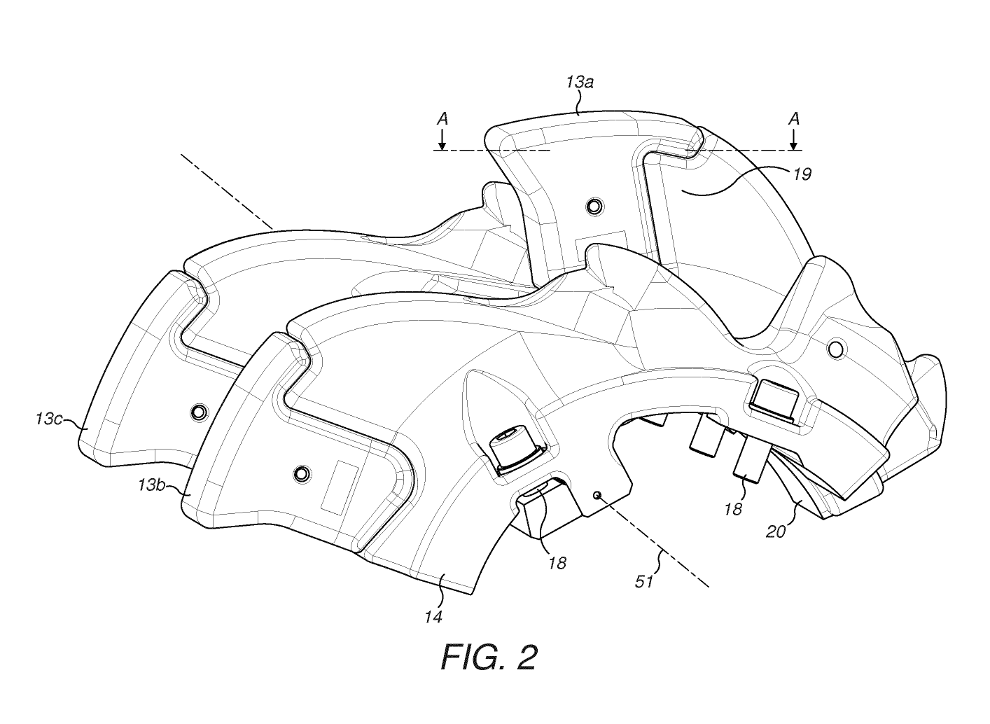

Referring to FIGS. 1 and 2, each roll 12 mounts a plurality of crushing segments illustrated generally by reference 14 that are mechanically attached to the roll 12 by attachment bolts 18 that extend through the segment 14 and into a suitable attachment region of the roll 12. Accordingly, a generally inward facing curved surface 20 of segment 14 may be mated against an outward facing attachment region (not shown) of roll 12. Each segment 14 detachably mounts a plurality of crushing teeth (alternatively termed crushing picks) 13. Teeth 13 are typically formed from a high hardness, high wear resistance material such as a high grade manganese steel. The main body of the segment 14 may also be formed from manganese steel or a high-strength quenched and tempered steel. Accordingly, teeth 13 are configured for resistance to high abrasive frictional wear with the bulk material and to withstand the significant high impact loading forces as the rolls 12 are rotated counter clockwise to one another to crush the bulk material via compression. Conventionally, teeth 13 are regarded as wear parts and typically require replacement at regular intervals with use. According to the specific implementation, segment 14 comprises three crushing teeth 13a, b and c, with each tooth 13a-c mountable to a respective radially raised mount section 19 of segment 14. Each section 19 is formed as a rib that projects radially outward from segment 14 so as to be generally upstanding relative to a radially inner region of segment 14 configured for attachment to the roll 12.

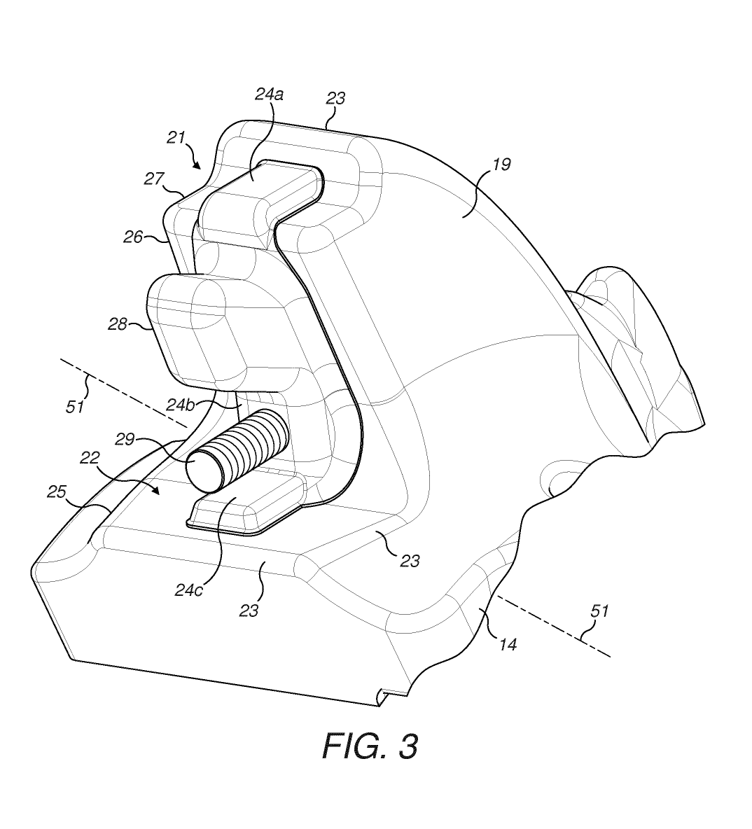

Referring to FIG. 3, each respective mount section 19 comprises a forward facing end adapted specifically to mount a respective tooth 13a-c. In particular, section 19 is terminated at its forward end by a mount region 21 that defines a first mount face 22 for mating with a corresponding mount face of tooth 13. According to the specific implementation, mount region 21 may be considered to be divided into a lower first tier 25, an upper second tier 27 and an undercut section 26 extending generally radially and connecting the first and second tiers 25, 27 relative to a rotational axis 51 of roll 12. A raised step extends centrally along the mount region 21 so as to comprise respective stepped sections 24a, 24b and 24c at the second tier 27, the undercut section 26 and the first tier 25, respectively. Stepped sections 24a, 24b and 24c collectively define a rib or ribbed sections extending along the mount region 21 from a radially outer region to a radially inner region relative to axis 51. A jib 28 having a generally rectangular cross sectional profile (according to the specific implementation) projects outwardly from mount region 21 and forward from the mount section 19 of crushing segment 14. The stepped sections 24a, 24b, 24c, jib 28 and the region immediately surrounding stepped sections 24a, 24b and 24c collectively define the first mount face 22 configured for positioning in close touching contact with the corresponding mount face of tooth 13. The first mount face 22 comprises a perimeter 23 that is defined by a change in the surface profile and contours of the crushing segment 14 (encompassing section 19). That is, the outward facing surface of the segment 14 is generally curved save for the first mount face 22 (that comprises various surface sections that are generally planar with such sections being interconnected by curved regions) with the junction between the curved outer surface of the segment 14 and the first mount face 22 defining the perimeter of the mount face 22.

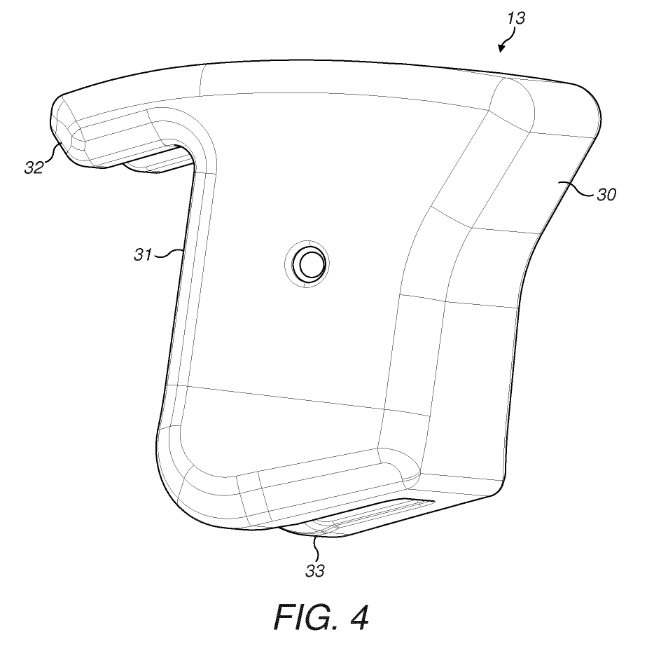

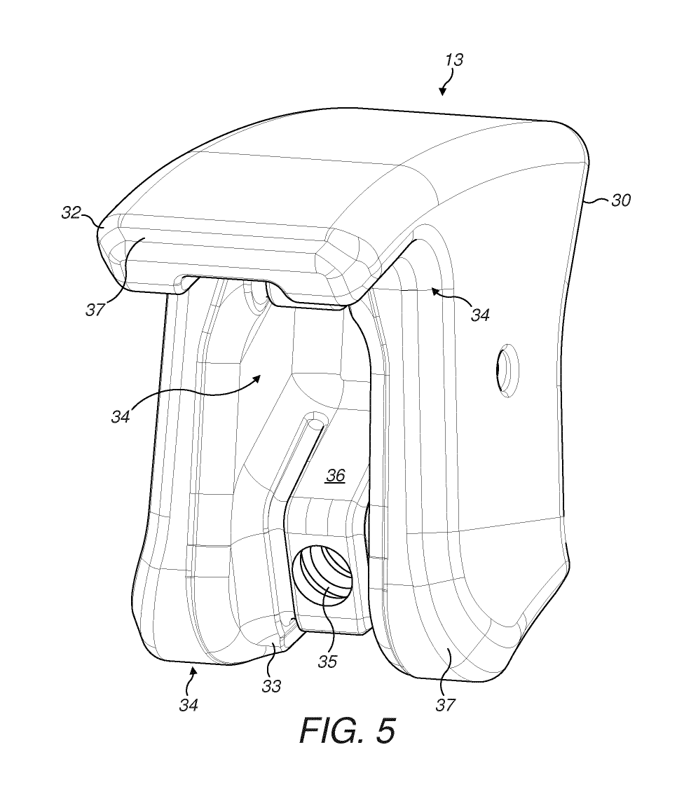

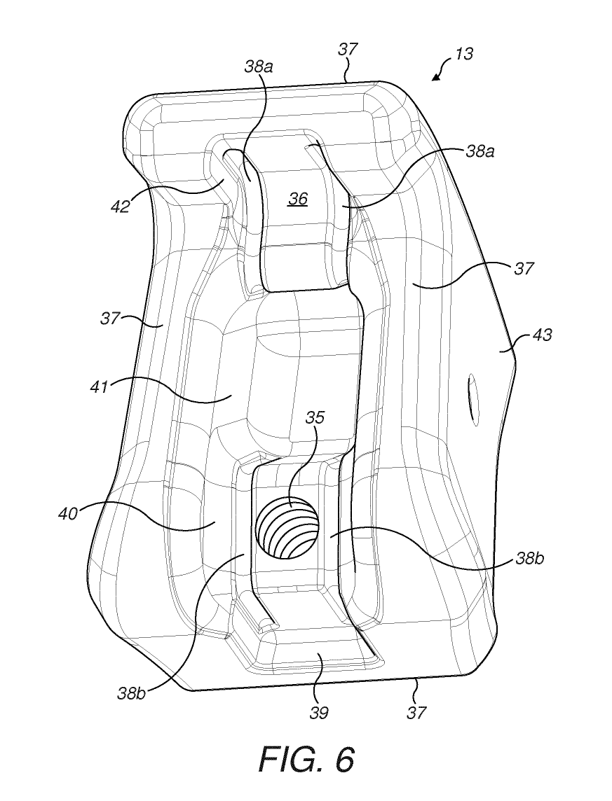

Referring to FIGS. 4 to 6, each tooth 13 is formed as a single body having a generally forward region or tip 30 (intended for initial impact with the bulk material) and a rearward region 31 (for mating against segment 14 and in particular tooth mount region 21). Tooth 13 further comprises a lower or radially inner region 33 for mounting generally against the mount region lower first tier 25. A flange 32 projects rearwardly from the rearward region 31 at an uppermost portion of tooth 13 furthest removed from lower region 33. Flange 32 is configured for abutment and seating against the upper second tier 27 of mount region 21.

The main body of tooth 13 comprises an internal cavity indicated generally by reference 36 that projects into tooth 13 from the rearward region 31. A corresponding second mount face 34 is presented at the tooth rearward region 31 and is defined, in part, by the internal cavity 36 and a region immediately surrounding or bordering the open end of cavity 36. According to the specific implementation, the shape profile and dimensions of the first and second mount faces 22, 34 are complementary so as to allow close fitting frictional contact between the respective faces 22, 34 as tooth 13 is seated at the segment 14 and in particular the forward end of section 19. In particular, a region of cavity 36 is dimensioned to accommodate and receive jib 28 and further regions of cavity 36 are configured to receive the respective stepped sections 24a, 24b, 24c of the mount region 21. Tooth second mount face 34 is defined by a perimeter 37 that is in turn defined by a change in the shape profile and contouring at the junction between an outward facing surface 43 of tooth 13 and the second mount face 34. In particular, tooth cavity 36 may be considered to comprise a lower first tier 39, a transition section 40, a jib recess 41 and an upper second tier 42 configured respectively for mating in opposed relationship to the lower first tier 25, undercut section 26, jib 28 and upper second tier 27 of the mount region 21, respectively. A pair of parallel aligned first channels 38b are further recessed into tooth cavity 36 and extend along the lower first tier 39 and transition section 40 to the jib recess 41. A corresponding pair of parallel aligned second channels 38a are also recessed into cavity 36 and extend between upper second tier 42 and jib recess 41.

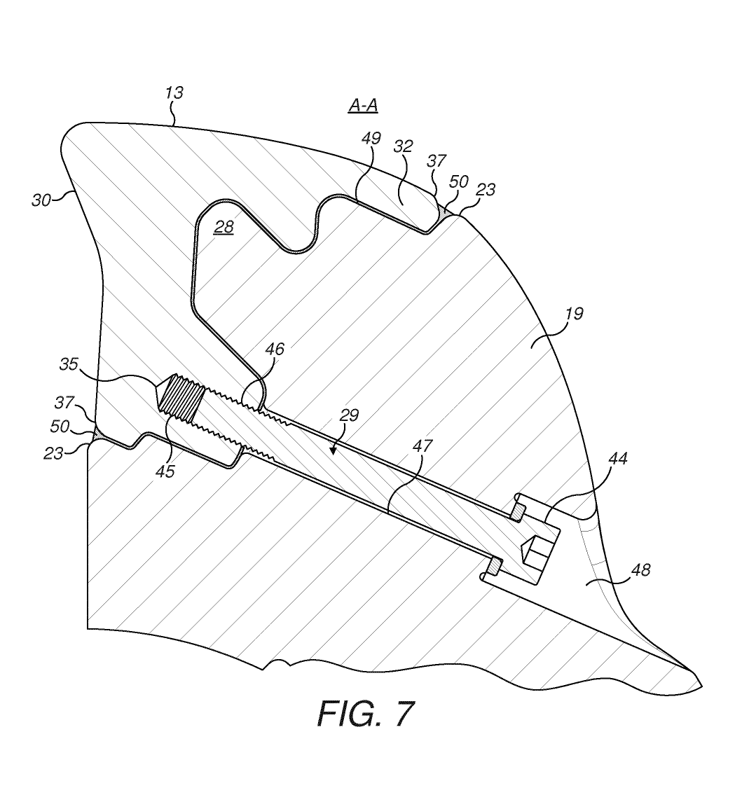

Referring to FIG. 7, tooth 13 is mechanically attached to crushing segment 14 via an attachment bolt 29 extending through segment section 19 and a lower region of tooth 13. In particular, section 19 comprises an internal bore 47 extending from the first mount face 22 (at a first lengthwise end section 19) to a mouth 48 at an opposite lengthwise end of section 19. Bolt 29 comprises a threaded first end 46 and an enlarged second head end 44 with the head end 44 capable of being accommodated within mouth 48. Tooth 13 comprises a corresponding internal bore 35 projecting inwardly from cavity 36 (at the transition section 40 between the jib recess 41 and lower first tier 39). Bore 35 comprises threads 45 to cooperate with corresponding threads of the bolt first end 46. Accordingly, tooth 13 is releasably attached to segment 14 via bolt 29 engaged into bores 47 and 35.

The multi-component crushing segment 14 further comprises a filler material 49 positioned respectively between the first and second mount faces 22, 34 of the teeth 13 and mount regions 21. According to the specific implementation, filler material 49 comprises a two-part epoxy material in which a two-part polymer and curing agent when mixed together initially form an epoxy resin that is capable of being maintained as a paste or fluid form for a predefined time period prior to curing. Once cured, filler material 49 is a solid having a shape profile corresponding exactly to that of a substrate or substrates to which the filler material 49 is placed in contact. To enhance the compressive strength, filler material 49 further comprises a powdered metal particulate included at a concentration range 85 to 95 wt % and more preferably 80 to 90 wt % based on a total weight of filler material 49.

Tooth 13 is mounted at crushing segment 14 according to the following procedure. Importantly, no milling, machining or grinding of the first and second mount faces 22, 34 is required so as to achieve a close fit and complete form closure between tooth 13 and the crushing segment mount region 21. In particular, the pre-set and flowable filler material 49 is applied to at least one or both of the respective first and second mount faces 22, 34. Tooth 13 is then pressed into position at mount region such that jib 28 is received within the respective jib recess 41 and the stepped sections 24a, 24b, 24c received respectively within the regions of cavity 36. Tooth 13 is pressed firmly against crushing segment 14 so as to ensure filler material 49 covers completely both the first and second mount faces 22, 34. The dispersion and delivery of the filler material 49 into all regions between tooth 13 and mount region 21 is facilitated by the flow channels 38a, 38b that guide and direct the flow of the filler material 49 so as to cover completely the respective mount faces 22, 34. Accordingly, filler material 49 provides an intermediate body connecting in full frictional contact tooth 13 the crushing segment 14. In particular, the first and second mount faces 22, 34 may be considered to define first and second parts of a mould cavity into which the filler material 49 is capable of setting so as to provide an intermediate skin or layer of material having a shape profile that conforms exactly to the surface profiling and contours of both the first and second mount faces 22, 34. Such a configuration is advantageous to provide and maintain a majority surface area contact between the respective mount faces 22, 34. In particular, filler material 49 ensures greater than 95% surface area contact between the tooth 13 and the crushing segment 14 with regard to the defined surface areas of the first and second mount faces 22, 34 (with such faces 22, 34 being defined by and contained within respective perimeters 23, 37).

To facilitate removal and interchange of a worn tooth 13, filler material 49 and/or crushing segment 14 are configured to inhibit or prevent bonding of the filler material 49 (and tooth 13) to the crushing segment 14. According to one implementation, an oil (such as a silicon or carbon based oil) may be applied initially to first mount face 22 prior to mounting of tooth 13 and contact with filler material 49. Accordingly, the initial oil coating prevents bonding of the material 49 to the first mount face 22. Interchange of worn teeth 13 may be achieved conveniently via release of attachment bolt 29 from its coupled position between tooth 13 and segment section 19.

Via the intermediate filler material 49, complete frictional contact is achieved between first and second mount faces 22, 34 to avoid the need for time and labour intensive machining. Additionally, the service lifetime of the crushing segment 14 is enhanced relative to conventional mechanisms of attachment as material at the crushing segment 14 does not require removal (for example via machining) and the tooth mount region 21 is not fatigued by applying a weld. Accordingly, the subject invention provides a mechanically robust attachment mechanism for a tooth at a crushing segment 14 that is further advantageous to facilitate attachment and interchange of crushing teeth 13 with regard to time, labour and personnel safety. The polymer based filler material 49 being bonded only to the tooth 13 (principally at tooth cavity 36) is conveniently removed from the crushing segment 14 as the tooth 13 is removed by release of attachment bolt 29. Efficient and optimised loading force transfer between the tooth 13 and crushing segment 14 is enhanced by coupling of the jib 28 within jib recess 41. Such a configuration increases the surface area contact between the tooth 13 and the tooth mount region 21 in addition to providing a tactile means of assisting with mounting the tooth 13 in mated position at the crushing segment 14. The projecting jib 28 and the corresponding jib recess 41 also facilitate with pressing the tooth 13 into its fully mated position against mount region 21 and the corresponding alignment of the perimeters 23, 37. As will be appreciated, it is advantageous to pre-load one or both of the mount faces 22, 34 with the pre-set polymer material 49 so as to ensure a sufficient volume of filler material 49 is provided to occupy all regions of the junction between tooth 13 and mount region 21. Any excess filler material indicated by reference 50 is expelled from between the mount faces 22, 34 so as to emerge at the junction between the respective face perimeters 23, 37 as illustrated in FIG. 7.

The polymer based filler material 49 is also advantageous to provide a visual aid as to when a tooth 13 has been worn through and requires replacement. This is possible via the colour difference between the metal tooth and the underlying polymer material 49 that is exposed with sufficient tooth wear.

1. A crushing segment forming a part of a crushing roll of a roll crusher, the segment comprising:
a main body provided or mountable at a crushing roll, the main body having at least one tooth mount region defined by a first mount face of the main body;
a crushing tooth having a second mount face mountable at the tooth mount region via positionally opposed mating contact between the first and second mount faces;
a mechanical attachment arranged to releasably attach the crushing tooth to the mount region; and
a filler material interposed between and extending over a majority of each of the positionally opposed first and second mount faces, the majority of the first and second mount faces being in frictional mating contact via the interposed filler material.

2. The segment as claimed in claim 1, wherein the filler material is a settable material configured to transition from a flowable fluid form to a generally solid form.

3. The segment as claimed in claim 1, wherein the filler material is a polymer resin.

4. The segment as claimed in claim 3, wherein the polymer resin is an epoxy based material.

5. The segment as claimed in claim 3, wherein the filler material includes a particulate additive.

6. The segment as claimed in claim 5, wherein the particulate additive is included within the filler material in the range 40 to 95 wt % based on a total weight of filler material.

7. The segment as claimed in claim 1 wherein the mechanical attachment is selected from any one or a combination of: a bolt, a screw, a pin, a bayonet fixing, and a tongue and groove attachment.

8. The segment as claimed in claim 1 wherein the filler material extends over 85 to 100% of the positionally opposed first and second mount faces.

9. The segment as claimed in claim 1 wherein the filler material extends to completely cover the positionally opposed first and second mount faces so as to occupy all of a junction between the mount region and the crushing tooth.

10. The segment as claimed in claim 1 wherein the mount region includes a jib projecting outwardly from the main body and the crushing tooth includes a cavity having a shape profile complementary to that of the jib to enable the jib to be seated within the cavity, the jib and the cavity defining at least a part of the respective first and second mount face.

11. The segment as claimed in claim 1, further comprising at least one channel, groove, rib, shoulder or stepped region provided at the mount region and/or the crushing tooth to define at least a part of the respective first and/or second mount face.

12. The segment as claimed in claim 1, wherein the mechanical attachment includes a bolt extending at least partially through the main body at the mount region and the bolt extending at least partially through the crushing tooth.

13. The segment as claimed in claim 1, comprising a plurality of mount regions and a corresponding plurality of crushing teeth, the filler material interposed respectively between each of the mount regions and the teeth.

14. A crushing roll for a roll crusher comprising at least one crushing segment as claimed in claim 1.

15. A roll crusher comprising at least one crushing roll as claimed in claim 14.
